(19) United States
(12) Patent Application Publication
(10) Pub. No.: US 2022/0120940 A1
(43) Pub. Date: Apr. 21, 2022

(54) SPHERICAL GRADIENT-INDEX LENS

(71) Applicant: NATIONAL CHIAO TUNG UNIVERSITY, Hsinchu City (TW)

(72) Inventors: Ruey-Bing HWANG, Hsinchu City (TW); You-Jheng LIN, Taipei City (TW)

(21) Appl. No.: 17/145,800

(22) Filed: Jan. 11, 2021

(30) Foreign Application Priority Data
Oct. 16, 2020 (TW) 109135851

(51) Int. Cl. G02B 3/00

(52) U.S. Cl. CPC G02B 3/0087; G02B 2003/0093

(57) ABSTRACT

A spherical gradient-index lens includes a sphere. The sphere is made of a dielectric material, and is formed with a plurality of cavities. Each of the cavities tapers from an outer surface of the sphere toward a center of the sphere. The cavities are spaced apart from one another, are substantially identical, and are substantially uniformly distributed in the sphere.

### CROSS-REFERENCE TO RELATED APPLICATION

This application claims priority of Taiwanese Patent Application No. 109135851, filed on Oct. 16, 2020.

### FIELD The disclosure relates to a lens, and more particularly to a spherical gradient-index lens.

### BACKGROUND

A Luneburg lens is a dielectric lens with a refractive index that presents spherically symmetric gradient. The refractive index of the Luneburg lens can be expressed by \sqrt{2−(a/A)²}, where “A” is a radius of the Luneburg lens, and “a” is a distance from a point in the Luneburg lens to a center of the Luneburg lens. That is, the refractive index of the Luneburg lens decreases radially from the center of the Luneburg lens to an outer surface of the Luneburg lens. Referring to FIG. 1, a conventional Luneburg lens includes a plurality of circular hollow cones 9 that have a common axis and a common vertex. Since the conventional Luneburg lens is only symmetric in the aspect of the azimuth coordinate (i.e., φ), but has poor symmetry in the aspect of the elevation coordinate (i.e., θ), its radiation performance diminishes in some directions. In addition, the circular hollow cones 9 have different dimensions, so the conventional Luneburg lens has a complex structure.

### SUMMARY

Therefore, an object of the disclosure is to provide a spherical gradient-index lens that can alleviate the drawbacks of the prior art.

According to the disclosure, the spherical gradient-index lens includes a sphere. The sphere is made of a dielectric material, and is formed with a plurality of cavities. Each of the cavities tapers from an outer surface of the sphere toward a center of the sphere. The cavities are spaced apart from one another, are substantially identical, and are substantially uniformly distributed in the sphere.

### BRIEF DESCRIPTION OF THE DRAWINGS

Other features and advantages of the disclosure will become apparent in the following detailed description of the embodiment with reference to the accompanying drawings, of which: FIG. 1 is a perspective view of a conventional Luneburg lens;

FIG. 2 a perspective view of an embodiment of a spherical gradient-index lens according to the disclosure; FIG. 3 is a perspective sectional view of the embodiment;

FIG. 4 is a schematic diagram illustrating each of a plurality of cavities of the embodiment;

FIGS. 5 to 11 are schematic diagrams illustrating each of the cavities in various modifications of the embodiment;

FIG. 12 is a schematic diagram illustrating a first circular cone and a second circular cone that are used when designing the embodiment; and

FIG. 13 is a plot illustrating simulated radiation performance of the embodiment.

### DETAILED DESCRIPTION

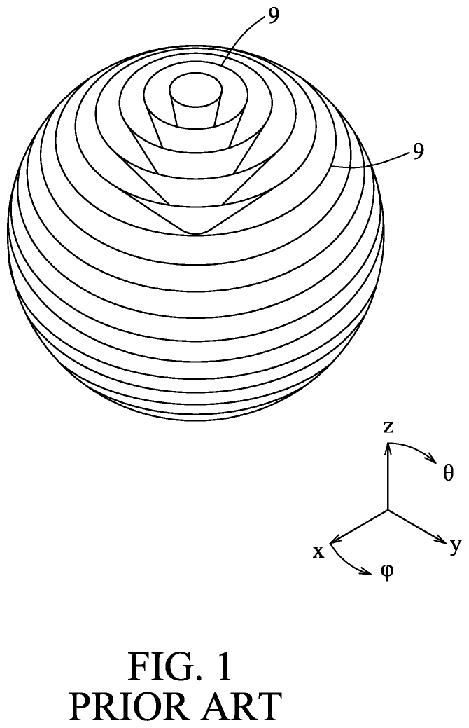

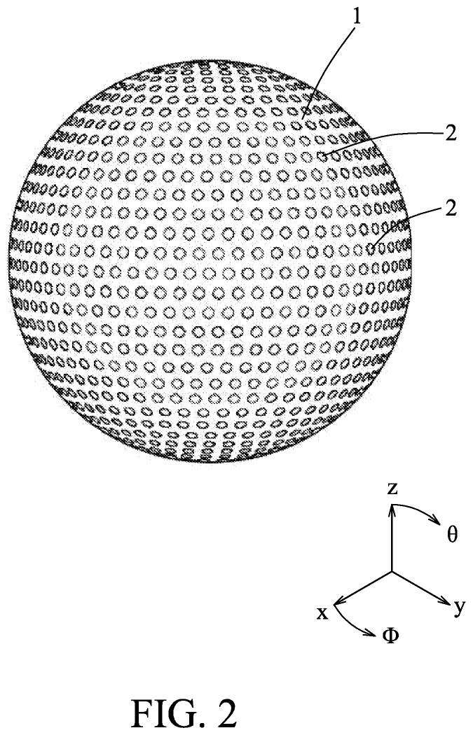

Referring to FIGS. 2 and 3, an embodiment of a spherical gradient-index lens according to the disclosure includes a sphere 1. The sphere 1 is made of a dielectric material, and is formed with a plurality of cavities 2. Each of the cavities 2 tapers from an outer surface of the sphere 1 toward a center of the sphere 1. Each of the cavities 2 has an opening located on the outer surface of the sphere 1. The cavities 2 are spaced apart from one another, are substantially identical, and are substantially uniformly distributed in the sphere 1; that is to say, included angles each between center axes of any adjacent two of the cavities 2 are substantially the same.

In this embodiment, a center-to-center distance between the openings of two adjacent ones of the cavities 2 on the outer surface of the sphere 1 is smaller than one-third of a wavelength of an incident electromagnetic wave to be received by the spherical gradient-index lens. In an embodiment, the center-to-center distance is smaller than one-fourth of the wavelength.

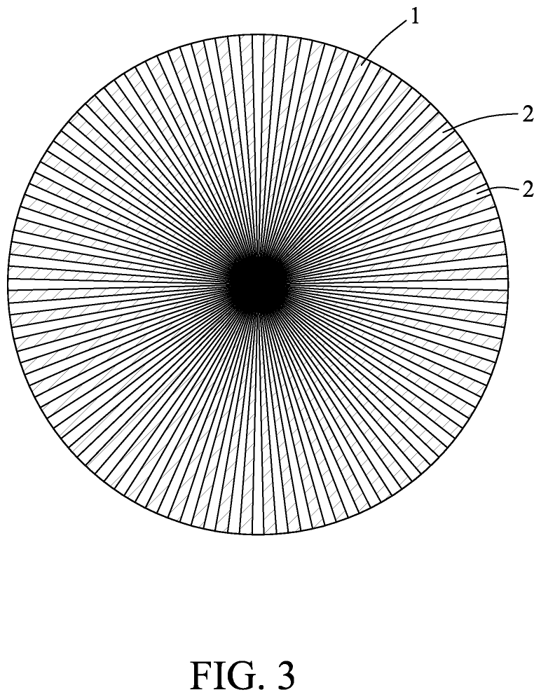

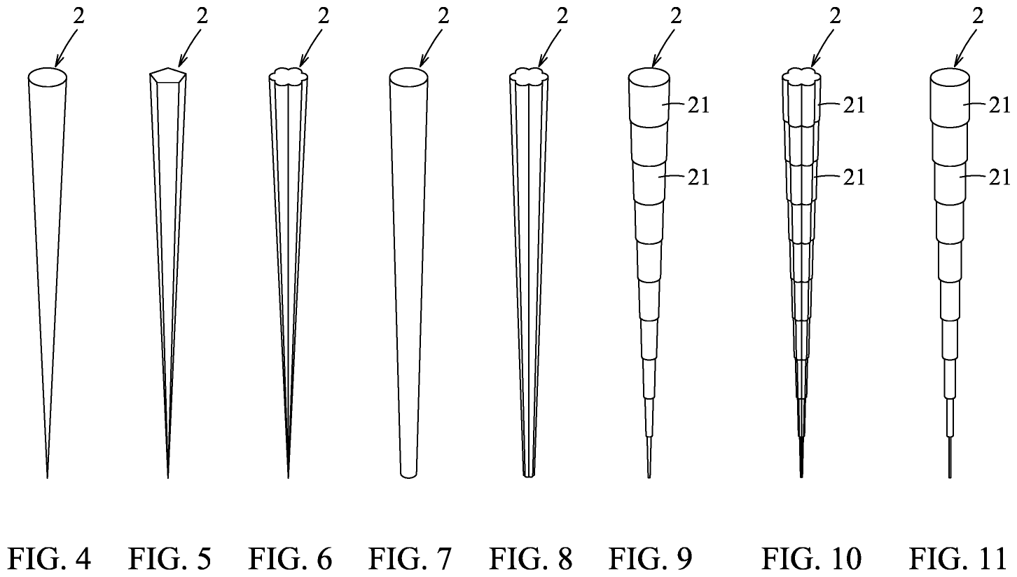

In this embodiment, as shown in FIG. 4, each of the cavities 2 has a cone shape, and a cross section of the cavity 2 on a plane normal to the center axis of the cavity 2 is circular, but the disclosure is not limited thereto. For example, the following modifications may be made to this embodiment.

1. The cross section of each of the cavities 2 may be non-circular. For example, the cross section may have the shape of a polygon, more particularly a pentagon as shown in FIG. 5, or the cross section may have a piecewise curved contour as shown in FIG. 6. The cross section may have an irregular shape in other embodiments.

2. Each of the cavities 2 may have a truncated cone shape, i.e., having the shape of a frustum, as shown in FIGS. 7 and 8, and the shape of the cross section of the cavity 2 may vary according to different design considerations. For example, the cross section of a frustoconical cavity 2 may be circular as shown in FIG. 7, or may have a piecewise curved contour as shown in FIG. 8.

3. Each of the cavities 2 may include a plurality of segmented portions 21 as shown in FIGS. 9 to 11, where the segmented portions 21 are arranged in series along the center axis of the cavity 2, and an end of one of the segmented portions 21 adjoining an end of a next one of the segmented portions 21 in the direction of tapering of the cavity 2 has dimensions larger than those of the end of the next one of the segmented portions 21. Each of the segmented portions 21 has one of a truncated cone shape and a cylinder shape, and a cross section of the segmented portion 21 on a plane normal to the center axis of the cavity 2 may vary according to different design considerations. In a first example as shown in FIG. 9, each of the segmented portions 21 has a truncated circular cone shape. In a second example as shown in FIG. 10, each of the segmented portions 21 has a truncated non-circular cone shape, and the cross section of the segmented portion 21 has a piecewise curved contour. In a third example as shown in FIG. 11, each of the segmented portions 21 has a cylinder shape, and the cross section of the segmented portion 21 is circular.

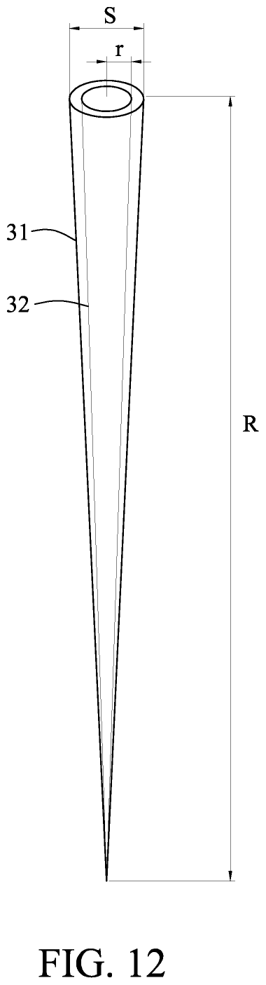

In this embodiment, the spherical gradient-index lens is a Luneburg lens, is fabricated using three-dimensional (3D) printing, and may be designed in a way as described below. Referring to FIGS. 2 and 12, first, define a first circular cone 31 and a second circular cone 32 that have a common axis and a common vertex. The first circular cone 31 has a height of R and a base diameter of S, where R is equal to a radius of the sphere 1, and S is substantially equal to the center-to-center distance between the openings of two adjacent ones of the cavities 2 on the outer surface of the sphere 1. The second circular cone 32 represents one of the cavities 2, and also has the height of R and has a radius of r, which is smaller than a half of the base diameter S of the first circular cone 31. Then, calculate a vertex angle of a first cross section of the first circular cone 31 taken along the center axis, and draw, on a plane and based on the vertex angle, a plurality of the first cross sections adjoining one another at their sides and a plurality of second cross sections each disposed inside a corresponding one of the first cross sections, where the second cross section is a cross section of the second circular cone 32 taken along the center axis of the second circular cone 32 (see the cross section of the spherical gradient-index lens shown in FIG. 3). The vertex angle thus calculated represents the included angle between the center axes of any adjacent two of the cavities 2. Finally, obtain the 3D structure of the spherical gradient-index lens based on a result of the drawing and spherical symmetry. Therefore, one only has to consider the parameters (R, r, S), the dielectric material and the shape of each of the cavities 2 when designing the spherical gradient-index lens of the disclosure to have desired refractive index distribution.

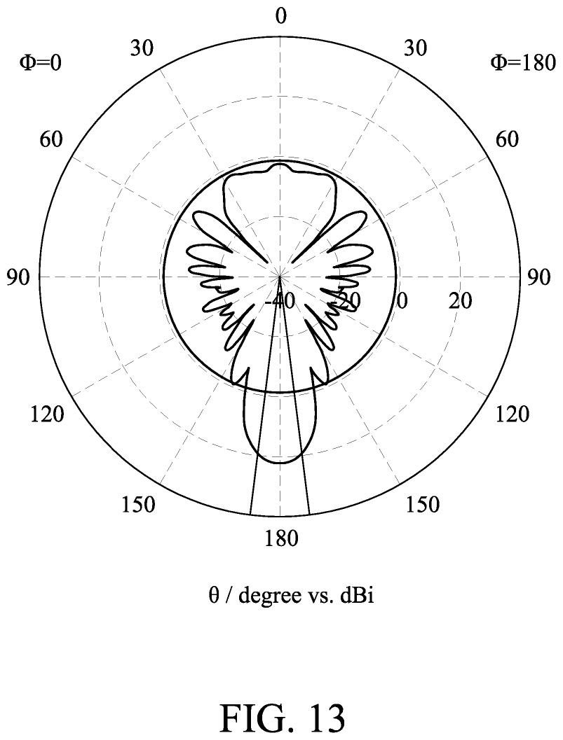

FIG. 13 is a radiation pattern illustrating simulated radiation performance of the spherical gradient-index lens of this embodiment in a scenario where the incident electromagnetic signal with a frequency of 28 GHz is fed to the spherical gradient-index lens via a waveguide. It is known from FIG. 13 that the spherical gradient-index lens has a far field gain (i.e. a main lobe level) of 22.3 dBi, a side lobe level lower than the main lobe level by 23.6 dB, and a half power beamwidth (HPBW) of 14.6°. In other words, the spherical gradient-index lens has a high radiation gain, a low side lobe level and high directivity.

In view of the above, in this embodiment, the spherical gradient-index lens has good symmetry, and therefore can radiate electromagnetic waves in all directions without degradation in radiation performance. In addition, the spherical gradient-index lens has a simple geometrical structure, which enhances freedom and ease of sizing the spherical gradient-index lens, which improves robustness of the spherical gradient-index lens, and which reduces printing material limitations and accuracy requirements of the 3D printing. Therefore, it is easy to design and fabricate the spherical gradient-index lens. The spherical gradient-index lens of the disclosure may be used in combination with radar transducers, antennas, miniaturized base stations, etc., or may be applied in various generations of mobile communication technologies (e.g., the fifth-generation mobile networks), satellite communications, autonomous vehicles, military aviation, etc.

In the description above, for the purposes of explanation, numerous specific details have been set forth in order to provide a thorough understanding of the embodiment. It will be apparent, however, to one skilled in the art, that one or more other embodiments maybe practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects.

While the disclosure has been described in connection with what is considered the exemplary embodiment, it is understood that the disclosure is not limited to the disclosed embodiment but is intended to cover various arrangements included within the spirit and scope of the broadest interpretation so as to encompass all such modifications and equivalent arrangements.

What is claimed is:

1. A spherical gradient-index lens comprising:
a sphere made of a dielectric material, and formed with a plurality of cavities;
wherein each of the cavities tapers from an outer surface of said sphere toward a center of said sphere;
wherein the cavities are spaced apart from one another, are substantially identical, and are substantially uniformly distributed in said sphere.

2. The spherical gradient-index lens of claim 1, wherein a center-to-center distance between two openings of two adjacent ones of the cavities on said outer surface of said sphere is smaller than one-third of a wavelength of an incident electromagnetic wave to be received by said spherical gradient-index lens.

3. The spherical gradient-index lens of claim 2, wherein the center-to-center distance is smaller than one-fourth of the wavelength.

4. The spherical gradient-index lens of claim 1, wherein each of the cavities has a cone shape.

5. The spherical gradient-index lens of claim 1, wherein each of the cavities has a truncated cone shape.

6. The spherical gradient-index lens of claim 1, wherein each of the cavities includes a plurality of segmented portions which are arranged in series along a center axis of the cavity, and each of which has one of a truncated cone shape and a cylinder shape.

7. The spherical gradient-index lens of claim 6, wherein for each of the cavities, an end of one of the segmented portions adjoining an end of a next one of the segmented portions in a direction of tapering of the cavity has dimensions larger than those of the end of the next one of the segmented portions.

8. The spherical gradient-index lens of claim 1, wherein a cross section of each of the cavities on a plane normal to a center axis of the cavity is circular.

9. The spherical gradient-index lens of claim 1, wherein a cross section of each of the cavities on a plane normal to a center axis of the cavity is a polygon.

10. The spherical gradient-index lens of claim 1, wherein a cross section of each of the cavities on a plane normal to a center axis of the cavity has a piecewise curved contour.

11. The spherical gradient-index lens of claim 1, wherein the cavities are substantially uniformly distributed such that included angles each between center axes of any adjacent two of the cavities are substantially the same.
